(19) United States
(12) Patent Application Publication
(10) Pub. No.: US 2013/0120559 A1
(43) Pub. Date: May 16, 2013

(54) METHOD AND SYSTEM FOR INSPECTING SURFACES OF MINIATURE COMPONENTS

(71) Applicant: LAWRENCE LIVERMORE NATIONAL SECURITY, LLC, Livermore, CA (US)

(72) Inventors: Eric Buice, Dublin, CA (US); Richard C. Montesanti, Pleasanton, CA (US); Nicholas A. Antipa, Oakland, CA (US); Alan D. Conder, Livermore, CA (US); Michael A. Johnson, Pleasanton, CA (US); John S. Taylor, Livermore (DE)

(73) Assignee: LAWRENCE LIVERMORE NATIONAL SECURITY, LLC, Livermore, CA (US)

(21) Appl. No.: 13/662,434

(22) Filed: Oct. 27, 2012

Related U.S. Application Data
(60) Provisional application No. 61/552,280, filed on Oct. 27, 2011.

(51) Int. Cl. H04N 7/18

(52) U.S. Cl. CPC H04N 7/18
USPC 348/125

(57) ABSTRACT

Systems and methods for inspecting capsules and capsule fill tube assemblies (CTFA) are provided. The 3-D Surface Mapping System (SMS) is used to generate 3-D surface information of each CFTA used in fusion ignition experiments. The CFTA includes a hollow capsule and an attached fill tube. This fragile CFTA's surface is inspected by using an optical microscope to gain volumetric information of particulates and surface defects at a sub-micrometer scale resolution. In order to completely inspect the entire surface of the CFTA the mechanical system requires multiple linear and rotational stages in addition to end effectors to safely hold the CFTA. By combining the optical microscope along with the mechanical system, a three-dimensional replication of the surface is generated providing information on surface feature defects and particulate sizes.

### CROSS-REFERENCES TO RELATED APPLICATIONS

This application claims the benefit of U.S. Provisional Application No. 61/552,280, filed Oct. 27, 2011, the full disclosure of which is incorporated by reference herein in its entirety for all purposes.

### STATEMENT AS TO RIGHTS TO INVENTIONS MADE UNDER FEDERALLY SPONSORED RESEARCH AND DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND

The present invention relates generally to a method and apparatus for inspecting the surface of components. More specifically, embodiments of the present invention relate to a method and apparatus for inspecting the surface of miniature components such as capsules and capsule fill tube assemblies (“CFTA”) for inertial fusion reactions.

Since the 1970's, scientists have experimented with powerful laser beams to compress and heat hydrogen fuel to the point of fusion in a technique called inertial confinement fusion. This technique is an approach to fusion that relies on the inertia of the fuel mass to provide containment. Research and development in this area is ongoing and aimed at developing an efficient inertial fusion energy (“IFE”) power plant. In such a plant, a small target is delivered into a fusion chamber and one or more high energy lasers impact the target at or near the center of the fusion chamber. The impact compresses and heats the hydrogen fuel of the target to initiate a fusion reaction. The fusion reaction produces high amounts of heat and radiation which may then be used to drive a conventional steam turbine for electricity production. This process would repeat at a high frequency, such as 1-20 times per second, so as to produce a continual supply of electricity.

Conventionally, inspecting miniature components, e.g., the target mentioned above, for surface defects is time-consuming and cumbersome. Even with recent advancements in the field of component inspection, there is a need in the art for a more robust and time-efficient method for inspecting miniature components.

### SUMMARY

In an IFE plant, a factory must produce a continuous supply of high-quality targets, e.g. a million targets per day. One component of the target is the hydrogen fuel capsule which may range in diameter between about 2 mm to about 2.6 mm. The surface of the capsule must be smooth and substantially free of defects over its entire surface in order to achieve inertial confinement nuclear fusion. Local defects may render the fuel capsule unacceptable for use in such a reaction. In addition to the fuel capsule, a fill tube may be attached to produce a capsule fill tube assembly (“CFTA”) which allows for filling the capsule with the hydrogen fuel. The fill tube may start off with a diameter of about 10 μm at the capsule fuel tube interface and may expand to about 20 μm over a length of about 2 mm. The fill tube may then step up in diameter to about 150 μm with an overall length of about 100 mm. Due to the size and configuration of the CFTA, it may be difficult for high volume inspections of capsule surfaces for defects which may interfere with a fusion reaction.

Certain embodiments of the present invention generally provide a system and method for inspecting the surface of miniature components for surface defects. In some embodiments, a system and method of inspecting the surface of a capsule fill tube assembly (“CFTA”) are provided. The system and method may optionally be used for quality assurance purposes. For example, embodiments of the present invention may be used as a metrology tool to measure three-dimensional surface defects to ensure that a CFTA meets required specifications. Additionally, some embodiments may provide volumetric information on particulate and surface defects at a sub-micrometer scale resolution. Further, 3-D surface information may be generated and archived for each scanned surface, such that information may be gained regarding the correlation between such defects and target implosion measurements taken during a fusion ignition experiment. Optionally, embodiments of the present invention may be automated in-part to reduce the number of handling steps required for inspecting the surface so as to reduce the possibility of damage due to handling errors. The inspection may detect surface scratches or foreign dust/particulate debris on the surface. In some embodiments, a system and method may be provided for achieving deterministic 4n steradian inspection of a CFTA.

For example, in one embodiment of the present invention, a system for inspecting the surface of a CFTA is provided. The exemplary embodiment may include an imaging device and a mechanical apparatus with multiple stages and end effectors for manipulating a coupled CFTA's orientation relative to the imaging device. The imaging device may be a confocal microscope and may also be coupled to multiple stages for aligning the imaging device relative to a coupled CFTA. The mechanical apparatus may include a first wand fixture configured to releasably couple to a CFTA. The first wand fixture may include a lumen for receiving the fill tube of a coupled CFTA such that the fill tube is concealed by the first wand fixture when a CFTA is coupled to it. The first wand fixture may releasably couple with the CFTA using vacuum suction; however other means may be used to releasably couple with the CFTA. The first wand fixture may be configured to rotate a coupled CFTA about multiple rotational axes to position the CFTA in different orientations relative to the imaging device. The imaging device may then scan the exposed surface of the CFTA in a plurality of incremental scans to generate surface image data. After the exposed surface of a CFTA is scanned, a second wand fixture may be used to expose the surface area initially covered by the first wand fixture, e.g., the interface between the fill tube and the capsule of the CFTA. The first wand fixture may disengage the capsule of the CFTA while the second wand fixture releasably couples to a portion of the capsule. Similar to the first wand fixture, the second wand fixture may utilize vacuum suction for releasably coupling to the capsule of the CFTA. The first wand fixture may then be withdrawn to expose a portion of the fill tube from the lumen of the first wand fixture. Thereafter the second wand fixture may rotate the capsule of the CFTA, bend the fill tube, and orient the capsule such that the imaging device may image the interface between the fill tube and the capsule of the CFTA. Optionally, the first wand fixture may be translated during the fill tube bending so as to reduce the forces exerted on the interface between the fill tube and the capsule. The image data from the scans may be stitched together to generate a three dimensional surface model of the capsule.

In an exemplary embodiment, the inspection apparatus may measure 4n steridian of a CFTA to inspect for surface scratches or foreign dust/particulates. Additionally, the inspection apparatus may provide volumetric data and a three dimensional surface model of the CFTA. This embodiment may also be automated in part to reduce the number of handling steps and the chances of damage to the CFTA from handling errors. Further, the embodiment may increase CFTA inspection throughput.

Although exemplary embodiments have been described in great detail above, many variations are available. Further features of the invention, its nature and various advantages will be more apparent from the accompanying drawings and the following detailed description.

### BRIEF DESCRIPTION OF THE DRAWINGS

FIG. 1 depicts a high-level flow diagram of an exemplary modified target assembly process according to embodiments of the present invention;

FIG. 2 illustrates an exemplary embodiment of a system for inspecting the surface of a CFTA according to an embodiment of the present invention;

FIG. 3 depicts a cross sectional image of a main wand fixture with a coupled CFTA;

FIG. 4 provides an exemplary high level method of inspecting the entire surface of a CFTA;

FIG. 5 provides an exemplary method for performing a scan of the unconcealed surface of a CFTA;

FIG. 6 provides another exemplary method for performing a scan of the unconcealed surface of a CFTA;

FIG. 7 provides an exemplary method for performing a scan of the previously covered surface area of the CFTA including the interface between the fill tube and the capsule;

FIGS. 8A-8C illustrate the exemplary method for performing a scan as provided in FIG. 7; and

FIG. 9 depicts and exemplary scan and a three dimensional surface profile generated according to methods and systems of the present invention.

### DETAILED DESCRIPTION

In the following description, various embodiments of the present invention will be described. For purposes of explanation, specific configurations and details are set forth in order to provide a thorough understanding of the embodiments. However, it will also be apparent to one of skill in the art that the present invention may be practiced without the specific details. Furthermore, well-known features may be omitted or simplified in order not to obscure the embodiment being described.

The method and system for provided herein may be used to inspect various types of objects. The dimensions and materials of the apparatus may vary depending on, for example, the intended use, the size and configuration of the object being inspected, and the desired inspection resolution and speed. Although embodiments described herein are generally directed to inspecting the surface of CFTAs, it should be understood that there is no intention to limit the invention to the type of object to be treated. Accordingly, the invention described herein should be limited only by the language of the claims.

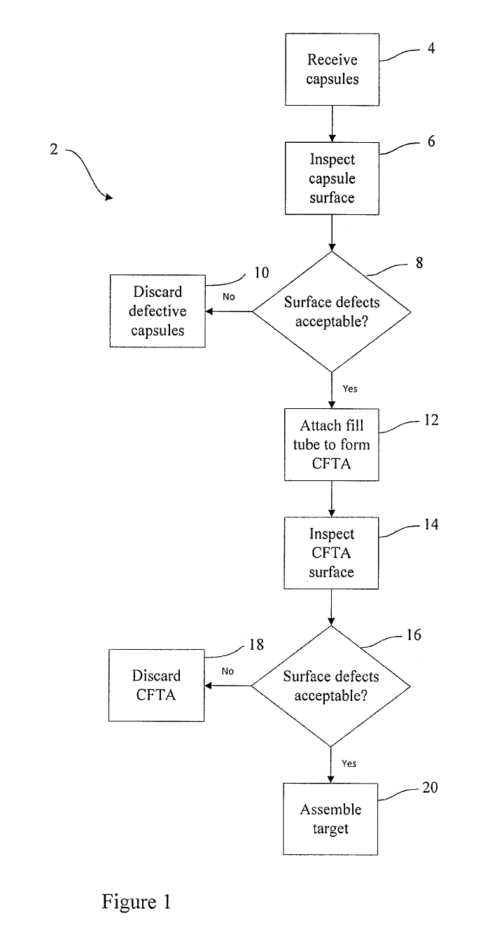

The method and system for inspecting miniature components may be used with current inertial fusion target assembly methods. As an example, FIG. 1 provides a high-level flow diagram of an exemplary modified target assembly process 2. At step 4, capsules are received for inspection. The capsules are inspected for surface defects at step 6 and at step 8 any detected defects may be characterized and archived to determine whether the number and size of defects are at an acceptable level. If the number and size of surface defects are not acceptable, the capsule is discarded at step 10. If the capsule surface meets set specifications, then a fill tube is attached to the capsule at step 12 to form a CFTA. Fill tube attachment step 12 may introduce surface defects during the handling of the capsule or attachment of the fill tube. Accordingly, a second inspection step may be performed at step 14. CFTA inspection step 14 may inspect the entire surface of the capsule including the fill tube capsule interface to determine whether surface defects were introduced to the capsule surface. If the CFTA no longer meets the set specifications at step 16, the CFTA is discarded at step 18. If the CFTA meets the set specifications, the CFTA may then be used for target assembly at step 20.

The received capsules at step 4 may be capsules which range in diameter from about 2 mm to about 2.6 mm. The capsule may be made from light or low atomic number elements. For example, a received capsule may comprise a beryllium shell which includes a radially tailored copper dopant to fine-tune its absorption of X-rays. Further the received capsule may be made of high-density carbon or may be a Ge doped plastic sphere. Many types of capsules may be received and inspected according to embodiments of the present invention.

The received capsule may undergo a first inspection 6 using an imaging device, such as an atomic force microscope, a confocal microscope, etc. Other imaging or measurement devices may be used in inspecting the surface of the received capsule. For example, a phase-shifting diffraction interferometer may be used to take a plurality of measurements to generate an entire surface map of the received capsule as described by Montesanti, et al., “Phase-Shifting Diffraction Interferometer for Inspecting NIF Ignition-Target Shells,” American Society for Precision Engineering Annual Conference, Oct. 15, 2006, the full disclosure of which is incorporated by reference herein. Optionally, a confocal microscope may be used for increased lateral resolution for scanning the capsule surface. The type of imaging device may depend on the desired inspection speed and resolution.

At step 8, any detected defect may be characterized and archived to determine whether the capsule may be used in an inertial fusion reaction process. For example, the defects may be classified in terms of volumetric size. Scratches on the surface may be characterized in terms of length and cross sectional area. Foreign dust/particulates may be characterized in terms of volume. Some defects alone may render the capsule unusable and such capsules may be discarded at step 10. Further, defects may be weighted depending on the defect size to determine whether the total number of defects exceeds a given threshold. If the threshold is exceeded, the capsule is discarded at step 10; otherwise, the capsule may proceed to step 12 where a fill tube is attached to form a CFTA.

At step 12, a fill hole may be laser-drilled into the received capsule. In some embodiments, a mandrel may need to be removed before attaching the fill tube. For example, a beryllium capsule may be manufactured using a smooth and spherical plastic mandrel. Beryllium may be deposited onto the mandrel as the mandrel is rolled or rotated until a 150 μm thick layer of beryllium has built up on the mandrel. After deposition, polishing, and inspection, the laser-drilled fill hole may be used to remove the mandrel from the capsule. The mandrel may be removed by heating the shell in an oxygen-rich atmosphere to pyrolyze or burn the plastic, resulting in gases which can escape through the fill hole. Thereafter, a glass fill tube may be attached to the capsule for filling the capsule with Deuterium/Tritium gas. Such a fill tube may be configured to have a diameter of 10 μm at the capsule fill tube interface and may expand to 20 μm over a length of 2 mm. The fill tube may then increase in diameter to 150 μm with a total length of 100 mm. The fill tube may be attached to the capsule with various chemical or mechanical means. For example, a fill tube may be attached to the capsule with UV hardened epoxy. Other fill tube configurations may be attached according to embodiments of the present invention. Optionally, in some embodiments of the method, the fill hole may be inspected with a device such as a phase-shifting diffraction interferometer prior to fill tube attachment.

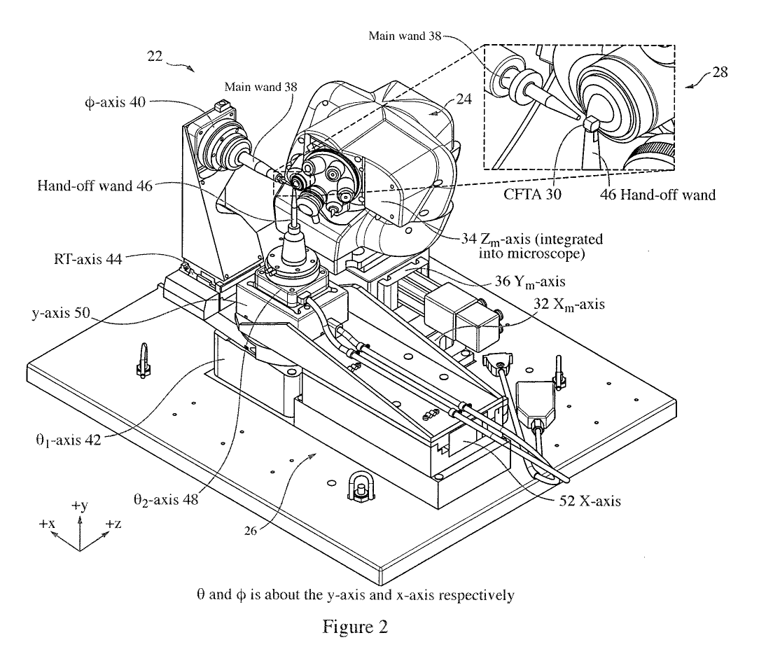

At step 14, the surface of the CFTA may be scanned to inspect for detects introduced from the fill tube attachment step. Embodiments of the present invention may be implemented in systems and methods for inspecting the surface of a CFTA at step 14. This step is similar to inspection step 8; however, due to the attachment of the fill tube, special considerations may be needed. A system for inspecting a CFTA is provided in FIG. 2. If the fill tube attachment step 12 introduces unacceptable surface defects such as glue contamination, the CFTA may be discarded at step 18. However, if the CFTA passes inspection at step 14, the CFTA may proceed to target assembly at step 20. At step 20, a CFTA may proceed to fusion target assembly, where, for example, the capsule may be filled with D-T gas fuel and fitted inside a hohlraum cylinder.

FIG. 2 illustrates an exemplary embodiment of a system 22 for inspecting the surface of a CFTA. System 22 includes an imaging device 24 and a mechanical apparatus 26. Inset 28 shows a close up of CFTA 30 relative to imaging device 24. Imaging device 24 may be coupled to a linear Xₘ-axis stage 32 for precision translation of imaging device 24 along the Xₘ-axis. Further, imaging device 24 may be coupled to a linear Yₘ-axis stage 36 for precision translation along the Yₘ-axis. In this particular embodiment, Zₘ-axis scanning 34 is integrated into imaging device 24.

Mechanical apparatus 26 includes a main wand fixture 38 (also referred to as “first wand fixture” or “first vacuum chuck”) and a hand-off wand fixture 46 (also referred to as “second wand fixture” or “transfer vacuum chuck”) in addition to a number of linear and rotational stages. Main wand fixture 38 is configured to releasably couple with CFTA 30. As can be seen in inset 28 in FIG. 2, main wand fixture 38 generally positions CFTA 30 adjacent to image device 24. Main wand fixture 38 is coupled to a φ-axis rotational stage 40 for rotating main wand fixture 38 about the φ-axis. Also, main wand fixture 38 is coupled to θ₁-axis rotational stage 42 for rotating main wand fixture 38 about the θ-axis. Moreover, main wand fixture 38 is also coupled to RT-axis stage 44 for radially translating and tangentially translating main wand fixture 38 relative to the θ-axis.

Hand-off wand fixture 46 is configured to releasably couple with CFTA 30. Hand-off wand fixture 46 is primarily used for imaging the interface between the fill tube and the capsule of CFTA 30 as will be described in further detail below. Hand-off wand fixture 46 is coupled to θ₂-rotational stage 48 for rotating hand-off wand fixture 46 about the θ-axis. Further, hand-off wand fixture 46 is coupled to y-axis stage 50 and x-axis stage 52 for translating hand-off wand fixture 46 along the y-axis and x-axis respectively. Accordingly, the illustrated embodiment includes seven linear stages and three rotational stages for orienting an attached CFTA 30 relative to imaging device 24 to achieve a deterministic 4π steradian inspection.

Image device 24 in FIG. 2 is a confocal microscope, however, it should be understood that other imaging or measuring devices may be used, such as a phase-shifting diffraction interferometer. In some embodiments, image device 24 may be able to locate and quantify surface features with a height of 50 nm and 300 nm in width or larger. In one embodiment of the invention, image device 24 may be configured to perform a scan in the z-direction using the Zₘ-axis from approximately 1 μm below the surface of CFTA 30 to approximately 1 μm above the surface. In some embodiments, image device 24 generates image data which may be stitched together to create a three dimensional surface model. Further, image device 24 may be calibrated such that a three dimensional surface model may be related to the capsule surface angular coordinate system to within about 0.25 degree (1σ), which corresponds to approximately 5 μm linear error on the capsule surface. It should be understood that the scanning specifications may be configured depending on various factors such as scanning speed and scanning resolution.

Image device 24 may have various objectives for different scanning modes. For example, in one mode, imaging device 24 may perform a preliminary or coarse scan of the surface of a CFTA 30 in order to determine areas of interest where defects may be present. After such an initial scan, a higher resolution lens may be used to examine the previously identified areas of interest. This dual mode scanning technique may be used to increase inspection throughput by limiting the number of high resolution scans to areas of interest.

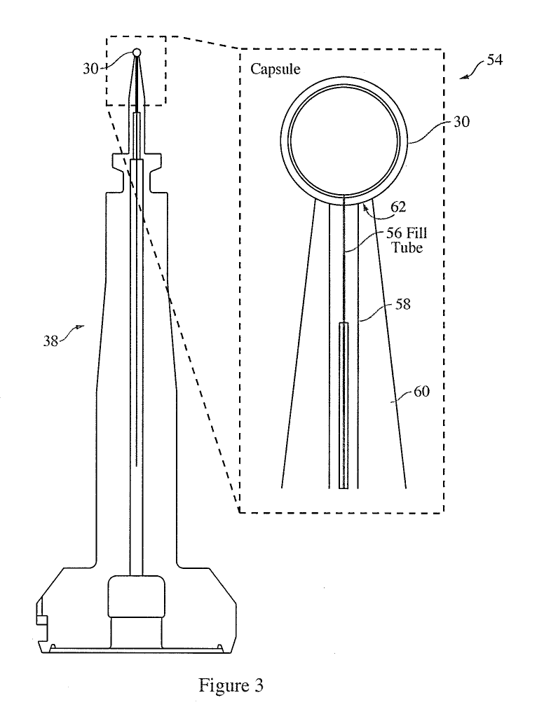

Main wand fixture 38 may be a vacuum wand which utilizes vacuum suction to releasably couple with CFTA 30. FIG. 3 depicts a cross sectional image of a main wand fixture with a coupled CFTA. As shown in inset 54 of FIG. 3, fill tube 56 of a coupled CFTA 30 may be inserted into inner lumen 58 of conical tip 60 of main wand fixture 38. Accordingly, fill tube 56 is substantially concealed by first wand fixture 38 when CFTA 30 is coupled to first wand fixture 38. Further, a portion 62 of the capsule is also concealed by first wand fixture 38 when CFTA 30 is coupled. The φ-axis rotational stage 40 and θ₁-axis rotational stage 42 may be used to orient an attached CFTA 30 relative to image device 24 such that image data may be gathered for most of the unconcealed surface of CFTA 30.

Referring back to FIG. 2, φ-axis rotational stage 40 is configured to rotate main wand fixture 38 about the φ-axis so as to rotate an attached CFTA 30 to a desired position relative to imaging device 24. For example, in one embodiment of the present invention, φ-axis rotational stage 40 rotates an attached CFTA 30 in a plurality of incremental steps about the φ-axis. In between each rotation increment, imaging device 24 may scan the surface of CFTA 30 for defects. The φ-axis rotational stage 40 may continue rotating CFTA 30 until 360° of image data is gathered about the φ-axis.

Similarly, θ₁-axis rotational stage 42 is configured to rotate main wand fixture 38 about the φ-axis so as to rotate an attached CFTA 30 to desired orientations relative to imaging device 24. For example, in one embodiment, θ₁-axis rotational stage 42 may rotate between 90° and about −26° about the θ-axis in a plurality of incremental steps. Between each rotation increment, image device 24 may scan the surface of CFTA 30 for defects. The θ₁-axis rotational stage 42 may have a rotational limit due to mechanical constraints. The method of using φ-axis rotational stage 40 and θ₁-axis rotational stage 42 to scan the majority of the unconcealed surface of CFTA 30 is described in further detail below.

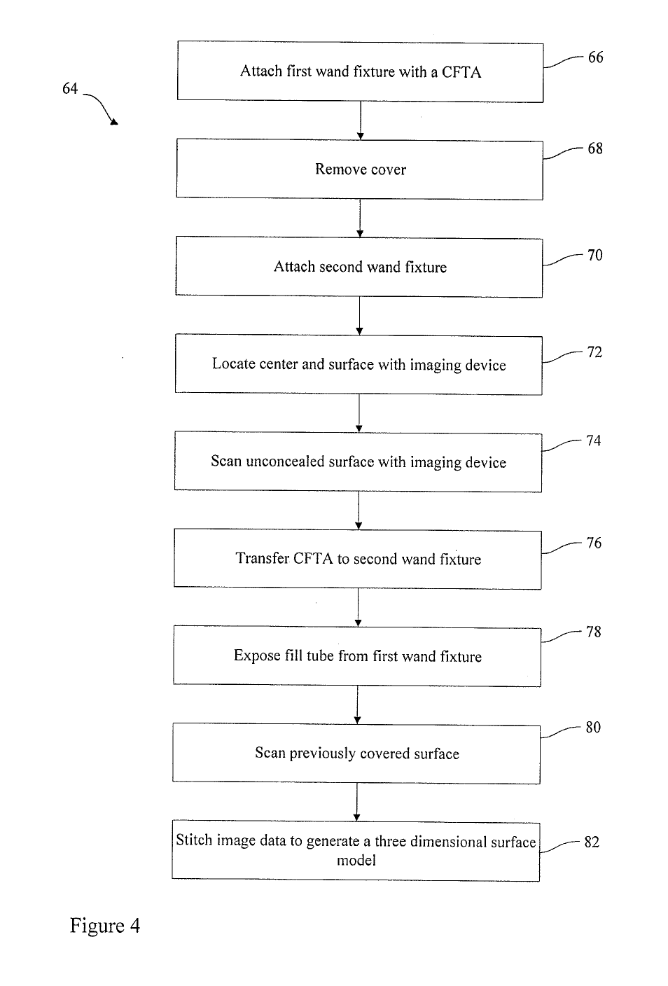

RT-axis stage 44, Xₘ-axis stage 32, Yₘ-axis stage 36, and Zₘ-axis stage 34 may be used for centering CFTA 30 relative to imaging device 24. Xₘ-axis stage 32 and Yₘ-axis stage 36 may be used to reposition imaging device 24 relative to CFTA 30 when θ₁-axis rotational stage 42 reaches its rotational limit. Additionally RT-axis stage 44 and y-axis stage 50 may be used for aligning and transferring CFTA 30 from main wand fixture 38 to hand-off wand 46. Hand-off wand 46 and coupled θ₂-axis stage 48 provide the capability of exposing the area initially covered 62 by primary wand 38. RT-axis stage 44 may also be used for reducing the forces on fill tube 56. The function and capabilities of the various stages will become more apparent from the accompanying discussion of method 64 for inspecting CFTA 30 in FIG. 4.

Turning now to FIG. 4, an exemplary method 64 of inspecting the entire surface of a CFTA 30 is provided at a high level. At step 66, primary wand fixture 38 with a coupled CFTA 30 is mounted to a φ-axis stage 40. In some embodiments, a cover may be attached to main wand fixture 38 for protecting CFTA 30 during transport and handling. If such a cover is present, it is removed at step 68. A second wand fixture 46 may be attached at step 70 after the cover is removed. At step 72, an image device 24 may locate the center and the surface of the attached CFTA 30. At step 74, CFTA 30 may be oriented in various positions relative to imaging device 24 so that image device 24 can scan the unconcealed surface of the capsule. After the majority of the surface has been scanned, CFTA 30 is transferred to second wand fixture 46 at step 76 for the purpose of scanning the interface between fill tube 56 and the capsule of CFTA 30. At step 78, first wand fixture 38 is withdrawn so as to expose a portion of fill tube 56. At step 80, previously concealed surface 62 of CFTA 30 is scanned. At step 82, image data is stitched to generate a three dimensional surface model.

The cover may be removed at step 68 by using a cover removal tool. The cover removal tool may be installed on θ₂-axis stage 48. The cover removal tool may then be driven towards main wand 38 using x-axis stage 52 until it is approximately 0.5 mm from making contact. At this point the cover may be unfastened from main wand 38 and mounted to the cover removal tool. During this process RT-axis stage 44 and y-axis stage 50 may be used to correct for any linear misalignments. The x-axis stage 52 may then be driven to move the cover away from main wand 38 to a location that the cover removal tool, along with the cover, can be safely removed and replaced with a hand-off wand 46 (step 70).

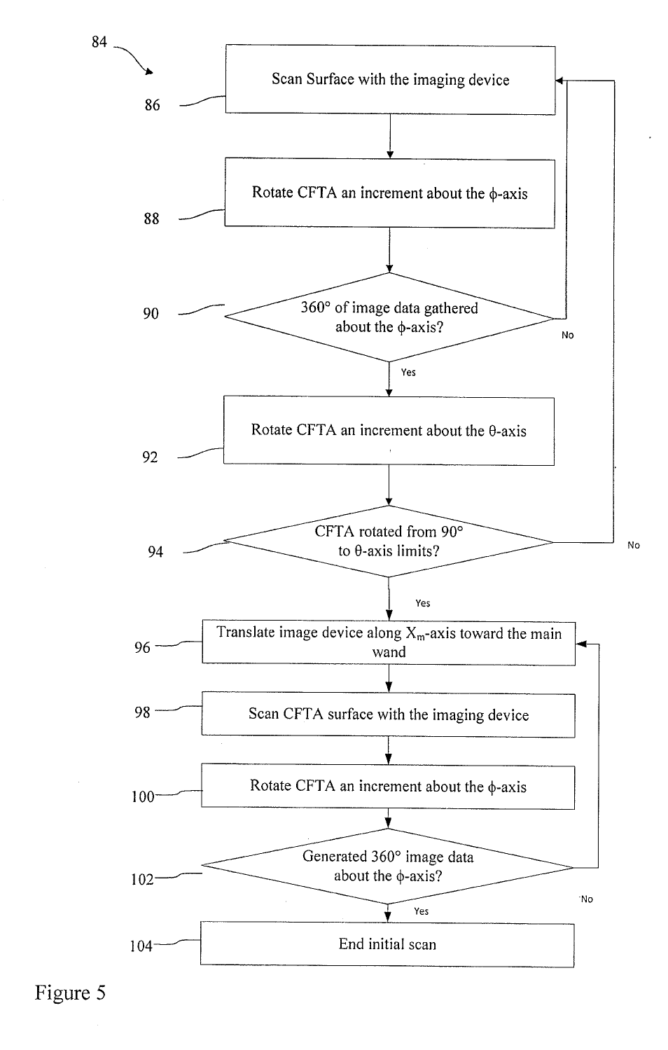

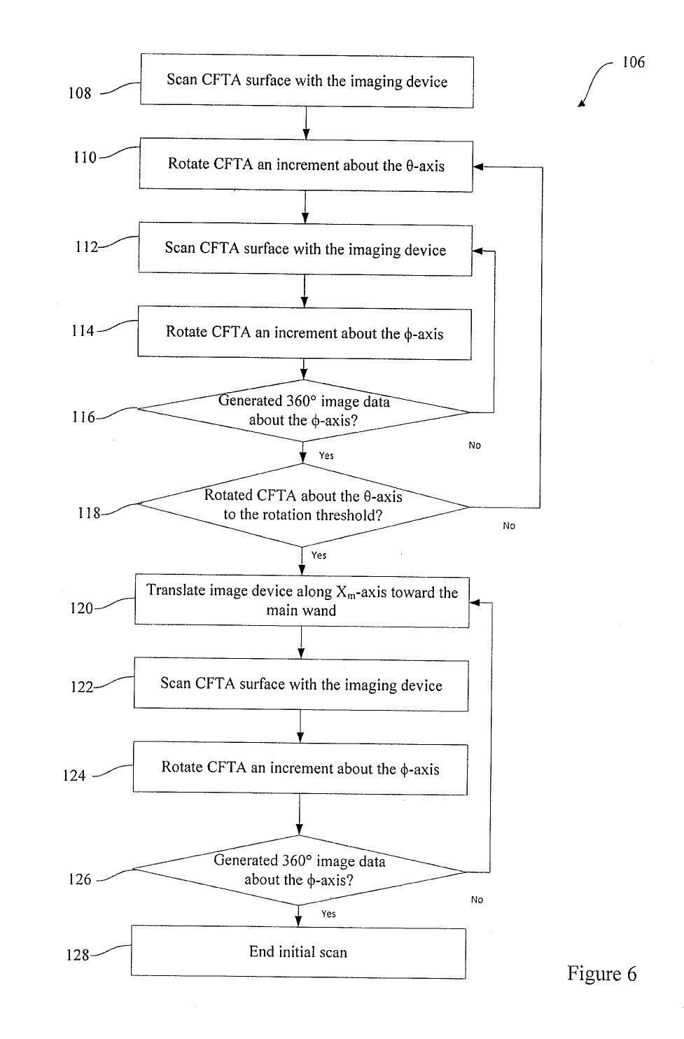

After removing the cover, imaging device 24 may be used to determine the center and surface location of CFTA 30 (step 72). To determine the center of CFTA 30, a combination of stages can be moved to position CFTA 30 in a desired location. These stages may include RT-axis stage 44, Xₘ-axis stage 32, Yₘ-axis stage 36, and Zₘ-axis stage 34. After imaging device 24 locates the center and surface of CFTA 30, scanning may be initiated (step 74). In one embodiment, the first image may be taken with the stages at their nominal home position by performing a scan in the z-direction using Zₘ-axis stage 34 from about 1 μm below the surface to about 1 μm above the surface. After scanning is complete, the rotational stages may reposition CFTA 30 relative to imaging device 24 to scan the remaining portions of the unconcealed surface (step 74) which will be described in more detail with a discussion of FIG. 5 and FIG. 6.

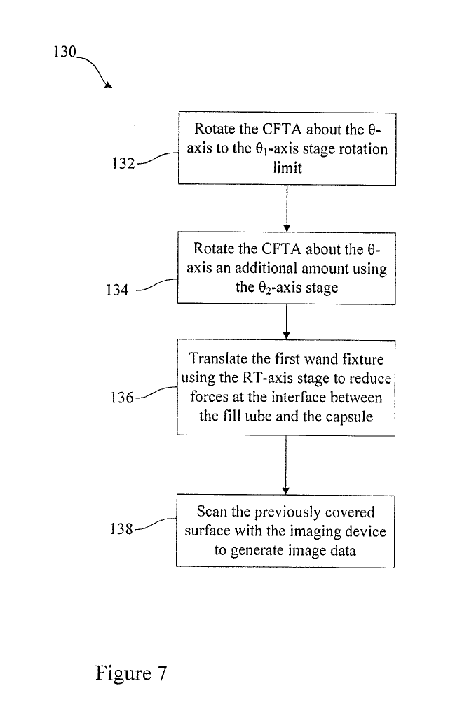

After the majority of the unconcealed surface has been scanned, CFTA 30 may be transferred to second wand fixture 46 (step 76) for imaging previously covered surface 62. In some embodiments, 95% of CFTA 30 surface can be imaged with image device 24 before transfer of CFTA 30. The remaining 5% of the surface is imaged by handing CFTA 30 to hand-off wand 46. In one embodiment, the hand-off is performed by moving x-axis stage 52 such that hand-off wand 46 is within approximately 100 μm of CFTA 30. At this point, RT-axis stage 44 and y-axis stage 50 may be used to adjust any misalignment between the axis of main wand fixture 38 and the axis of hand-off wand fixture 46 tip. Once the appropriate alignment is achieved, vacuum is turned on at hand-off wand fixture 46 while turning off vacuum at main wand fixture 38. CFTA 30 may then transfer to hand-off wand 46. After the hand-off is performed R-axis stage 44 may be driven to expose a portion of fill tube 56 from first wand fixture 38 (step 78). In one embodiment, approximately 2.5 mm of fill tube 56 is exposed. Thereafter, previously covered portion 62 of CFTA 30 may be imaged which is described in further detail with a discussion of FIG. 7. Image data gathered from the scanning may be stitched together to generate a three dimensional surface model (step 82).

FIG. 5 provides an exemplary method 84 for performing initial scan 74 of the unconcealed surface of a CFTA 30. At step 86, imaging device 24 performs a scan of the CFTA 30 surface. At step 88, CFTA 30 is rotated an increment about the φ-axis using φ-axis stage 40. The incremental step may be determined by the magnification of the objective used during the measurement. Additional scans (step 86) are performed by imaging device 24 and CFTA 30 is rotated additional increments (step 88) until 360° of surface image data are gathered about the 4-axis (step 90). At step 92, CFTA 30 is rotated an increment about the θ-axis using θ₁-axis stage 42. The increments of θ₁-axis stage 42 will be performed through its travel limits. In one embodiment the travel limits may be −26° to +90°. At each incremental step about the θ-axis, the plurality of φ-axis scans are repeated (steps 86 and 88) until 360° of surface image data are gathered (step 90). After CFTA 30 has been rotated from 90° to the θ-axis travel limit (step 94), some embodiments may translate imaging device 24 along the Xₘ-axis using Xₘ-axis stage 32 toward main wand 38 at step 96. Once imaging device 24 is at its new location, CFTA 30 may be scanned (step 98) and rotated about the φ-axis (step 100) until 360° of surface image data are gathered (step 102). Thereafter the initial scan is complete at step 104. In some embodiments, approximately 95% of CFTA 30 surface may be imaged with this exemplary method.

FIG. 6 provides another exemplary method 106 for performing initial scan 74 of the unconcealed surface of CFTA 30. In this exemplary method, main wand 38 is positioned at +90° about the θ-axis. This may be the nominal home position of main wand fixture 38 or main wand 38 may be rotated to +90° about the θ-axis using θ₁-axis stage 42 (such that the φ-axis is analogous to the scanning axis of imaging device 24) before scanning is initiated. At step 108, imaging device 24 performs a scan of the CFTA 30 surface. At step 110, CFTA 30 is rotated an increment about the θ-axis using θ₁-axis stage 42. Imaging device 24 performs another scan of the CFTA 30 surface at step 112. At step 114, CFTA 30 is rotated an incremental step about the φ-axis using φ-axis stage 40. At step 116, additional scans (step 112) are performed and CFTA 30 is rotated additional increments about the φ-axis (step 114) until 360° of surface image data are gathered. At step 118, additional strips of 360° image data area gathered (step 112 and step 114) for each incremental step about the θ-axis (step 110) until CFTA has rotated from 90° to its rotational threshold. Thereafter, in some embodiments, steps 120-126 may be performed as described above to scan the majority of the unconcealed surface area. At step 128, the initial scan is complete and the method may proceed to scan the previously covered surface 62 of CFTA 30.

In between each incremental step, image device 24 may once again determine the center of CFTA 30. RT-axis stage 44 and Yₘ-axis stage 36 may be used to position CFTA 30 to its ‘original’ location. By continuously determining the center of CFTA 30, the system and method may be able to correct for small error motions induced by the stages and mounting misalignment of main wand 38. Additionally, the re-centering steps may automatically compensate for thermal growth of the instrument 22. Alternatively, some embodiments may not determine the center of CFTA 30 after each measurement as the overall surface measurement time of CFTA 30 is increased with each subsequent re-centering. Instead, some embodiments may predetermine the position correction at different steps by performing a calibration routine prior to surface mapping. It should be apparent that many other alternative scanning methods are available for scanning the majority of unconcealed surface area and these exemplary methods are provided by way of example only.

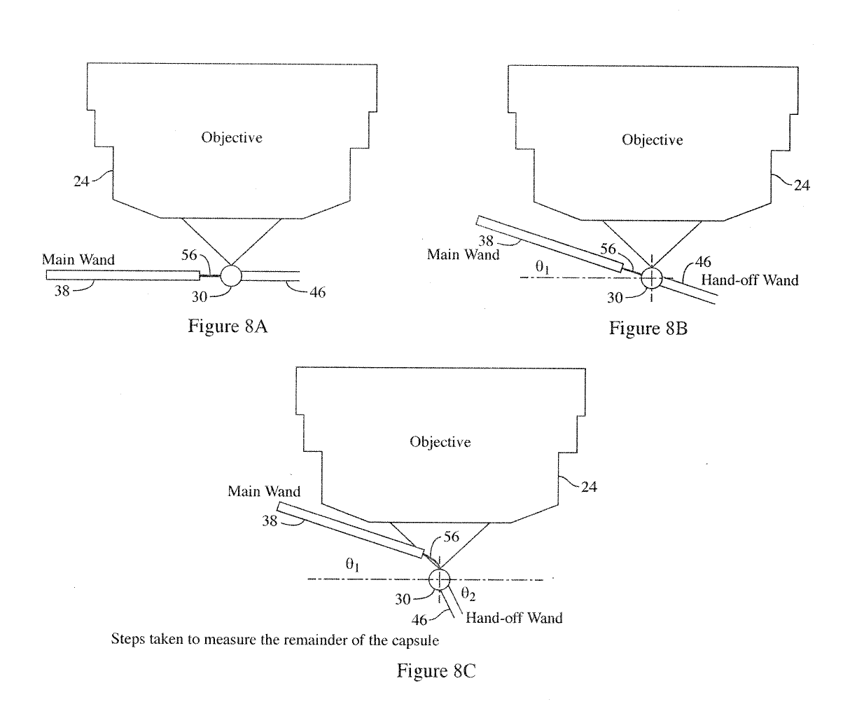

FIG. 7 provides an exemplary method 130 for performing second scan 80 of previously covered surface 62 of CFTA 30. At step 132, CFTA 30 is rotated about the θ-axis to the θ₁-axis stage 42 rotation limit. At step 134, CFTA 30 is rotated about the θ-axis an additional increment using hand-off wand 46 and θ₂-axis stage 48. This additional rotation of CFTA 30 causes fill tube 56 to bend as shown in FIGS. 8A-8C. For example, in one embodiment, θ₂-axis stage 48 may rotate CFTA 30 an additional 60° about the θ-axis. At step 136, first wand fixture 38 may be translated using RT-axis stage 44 to reduce forces at the interface between fill tube 56 and the capsule. At step 138, image device 24 may then scan previously covered surface 62 to generate image data.

FIGS. 8A-8C illustrate the exemplary method 130 of FIG. 7. In this embodiment, hand-off wand fixture 46 is opposite of main wand fixture 38 rather than perpendicular to the main wand fixture axis. FIG. 8A shows CFTA 30 transferred to hand-off wand 46. Additionally main wand fixture 38 has been withdrawn a distance to expose fill tube 56. FIG. 8B illustrates step 132 of method 130—CFTA 30 is rotated about the θ-axis at an increment θ₁. In some embodiments θ₁ may be the rotational limit of main wand fixture 38. For example, in some embodiments the rotational limit of θ₁-axis stage 42 may be −26°. In FIG. 8C, hand-off wand 46 rotates CFTA 30 about the θ-axis an additional increment θ₂ which causes fill tube 56 to bend. Main wand fixture 38 may be translated using RT-axis stage 44 to minimize the forces on the interface between fill tube 56 and the capsule. Image device 24 may then scan previously covered surface area 62 including the interface between fill tube 56 and the capsule (step 138) for surface defects. Optionally, a three dimensional surface model may be generated of the area. In some embodiments image device 24 may be repositioned using Xₘ-axis stage 32 and Yₘ-axis stage 36 to stitch multiple images together to complete the surface mapping. After completing the surface mapping of CFTA 30, the steps may be reversed such that CFTA 30 is once again held by main wand fixture 38. A cover may be placed on to main wand fixture 38 using the cover removal tool. Thereafter, CFTA 30 along with main wand 38 may be transferred to the next step of the assembly of a fusion ignition target.

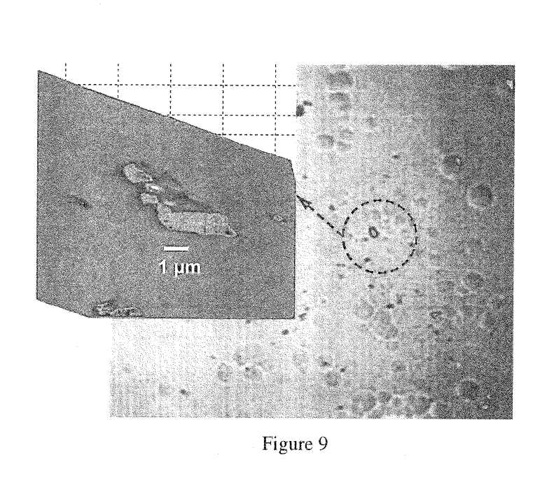

FIG. 9 depicts an exemplary image patch and three dimensional surface model generated by image device 24. As set forth above, imaging device 24 may be a confocal microscope for capturing the surface of CFTA 30 to ensure quality assurance standards are met. FIG. 9 illustrates a spherical test sample, including deliberate surface defects and contamination. FIG. 9 shows a 20× confocal image of the spherical test sample. The inset in FIG. 9 is a perspective view of height data from a signal particle at 100× magnification. Using a stitching algorithm, a three dimensional surface profile of the entire surface may be generated with the use of individual images, such as the one shown in FIG. 9.

The system and method for inspecting surfaces of miniature components is a vital part of building a complete Fusion Ignition Target. The system and method is an enabling technology to facilitate a quality assurance program and a system for archiving surface information of each CFTA used in a fusion ignition experiment. To measure the surface of the CFTA, seven linear and three rotational stages and an optical microscope may be used. The system and method may completely characterize the surface of the CFTA. The imaging system and method may provide three dimensional surface characteristics along with a coordinate system that identifies each individual surface defect and particulate. Such a coordinate system may be directly correlated to the final fusion ignition target along with the coordinate system of a target chamber. A correlation between coordinate systems, allows for a detailed study of the impact of surface defects and dust particles on the ability of a target to achieve credible fusion ignition. This system and method may be fully automated so as to reduce the amount of operator assistance. This not only improves inspection throughput, but also enhances CFTA safety. Additionally, the system can provide a multitude of measurements by using different measurement technologies such as optical, interferometric, tactile probes and scanning probe microscopy. These different measurement technologies can also be combined such that the individual measurements are performed in parallel or in series.

While the invention is susceptible to various modifications and alternative constructions, certain illustrated embodiments thereof are shown in the drawings and described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The terms “comprising,” “having,” “including,” and “containing” are to be construed as open-ended terms (i.e., meaning “including, but not limited to”) unless otherwise noted. The term connected is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individual recited herein. All methods described herein can be performed in any suitable order unless otherwise indicated or clearly contradicted by context. The use of any and all examples or exemplary language is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated or otherwise clearly contradicted by context.

What is claimed is:

1. A method of generating a surface model of a capsule fill tube assembly (CFTA), wherein the CFTA comprises a capsule and a fill tube, the method comprising:
upon coupling the CFTA to an end of a first wand fixture of an inspection apparatus, wherein the fill tube extends into a lumen of the first wand fixture, scanning, by the inspection apparatus, the CFTA using an imaging device to generate image data;
transferring, by the inspection apparatus, the CFTA from the first wand fixture to a second wand fixture associated with the inspection apparatus;
exposing, by the inspection apparatus, a portion of the fill tube from the first wand fixture; and
scanning, by the inspection apparatus, the CFTA with the imaging device at an interface between the fill tube and the capsule to generate image data.

2. The method of claim 1, wherein the step of scanning using the imaging device to generate image data comprises:
(a) imaging the CFTA with the imaging device along a scanning axis to generate image data;
(b) rotating the CFTA an increment about a first rotational axis so as to position the CFTA in a different orientation relative to the imaging device, the first rotational axis not coincident to the scanning axis; and
(c) repeating steps (a) and (b) until the CFTA is rotated through at least 90 degrees in a plurality of increments about the first axis.

3. The method of claim 2, wherein the first axis is perpendicular to the scanning axis.

4. The method of claim 3, wherein the step of scanning using the imaging device to generate image data further comprises:
(d) rotating the CFTA an increment about a second axis using the first wand fixture so as to position the CFTA in a new orientation relative to the imaging device, the second axis perpendicular to the scanning axis and the first axis; and
(e) repeating steps (a), (b), (c), and (d) until the CFTA is rotated through at least 90 degrees in a plurality of increments about the second axis.

5. The method of claim 4, wherein step (e) is performed until the CFTA is rotated through at least 120 degrees in a plurality of increments about the second axis.

6. The method of claim 4, wherein step (e) is performed until image data is generated for about 90% of the CFTA surface.

7. The method of claim 4, wherein the step of scanning using the imaging device to generate image data further comprises translating the image device relative to the CFTA.

8. The method of claim 1, wherein the step of scanning the CFTA with the imaging device comprises rotating the CFTA, the first wand fixture, and the second wand fixture by a first predetermined amount.

9. The method of claim 8, wherein the step of scanning the CFTA with the imaging device further comprises rotating the CFTA by a second predetermined amount using the second wand fixture so as to expose the interface between the fill tube and the capsule to the imaging device, and wherein the step of rotating the CFTA a second predetermined amount causes the fill tube to bend.

10. The method of claim 9, wherein the step of scanning the CFTA with the imaging device further comprises translating the first wand fixture relative to the CFTA to reduce forces exerted on the interface between the fill tube and the capsule due to the bending of the fill tube.

11. The method of claim 1, further comprising:
transferring the CFTA from the second wand fixture back to the first wand fixture;
placing a cover on the first wand fixture; and
stitching the image data together to form the surface model.

12. The method of claim 1, further comprising performing a calibration routine on the first wand fixture, the second wand fixture, and the imaging device.

13. An apparatus for inspecting a surface of a capsule fill tube assembly (CFTA), wherein the CFTA comprises a capsule and a fill tube, the apparatus comprising:
an imaging device for scanning the surface of the CFTA along an scanning axis to generate image data;
a first wand fixture configured to releasably couple with the CFTA and having a lumen, the lumen configured to receive the fill tube;
a first rotational stage coupled to the first wand fixture for rotating the first wand fixture about a first rotational axis perpendicular to the scanning axis such that a coupled CFTA may be scanned by the imaging device about the first rotational axis;
a second rotational stage coupled to the first wand fixture for rotating the first wand fixture about a second rotational axis, the second rotational axis perpendicular to the first rotational axis and the scanning axis;
a second wand fixture configured to releasably couple with the CFTA; and
a third rotational stage coupled to the second wand fixture for rotating the second wand fixture about the second rotational axis.

14. The apparatus of claim 13 further comprising an XY linear stage coupled to the imaging device.

15. The apparatus of claim 13 further comprising a first linear stage coupled to the first wand fixture, the first linear stage configured to translate the first wand fixture radially from the second rotational axis.

16. The apparatus of claim 13 further comprising a second linear stage coupled to the first wand fixture, the second linear stage configured to translate the first wand fixture tangentially relative to the second axis.

17. The apparatus of claim 13 further comprising a fourth linear stage coupled to the second wand fixture, the fourth linear stage configured to translate the second wand fixture along the second rotational axis.

18. The apparatus of claim 13 further comprising a fifth linear stage coupled to the second wand fixture, the fifth linear stage configured to translate the second wand fixture perpendicular to the scanning axis and the second rotational axis.

19. The apparatus of claim 13 wherein the second rotational stage is coupled to the second wand fixture.

20. A method of generating a surface model of a capsule fill tube assembly (CFTA), wherein the CFTA comprises a capsule and a fill tube, the method comprising:
coupling, by an inspection apparatus, the CFTA to an end of a first wand fixture of the inspection apparatus such that the fill tube extends into a lumen of the first wand fixture;
scanning, by the inspection apparatus, the CFTA with the imaging device to generate image data;
transferring, by the inspection apparatus, the CFTA from the first wand fixture to a second wand fixture of the inspection apparatus;
exposing, by the inspection apparatus, a portion of the fill tube from the first wand fixture; and
scanning, by the inspection apparatus, the CFTA with the imaging device at an interface between the fill tube and the capsule to generate image data; and
stitching, by the inspection apparatus, generated image data together to produces a three dimensional surface model.
